(19) United States
(12) Patent Application Publication
(10) Pub. No.: US 2026/0168842 A1
(43) Pub. Date: Jun. 18, 2026

(54) LOAD ESTIMATING DEVICE FOR VEHICLE

(71) Applicant: TOYOTA JIDOSHA KABUSHIKI KAISHA, Toyota-shi (JP)

(72) Inventor: Katsuya SASAKI, Nagoya-shi (JP)

(73) Assignee: TOYOTA JIDOSHA KABUSHIKI KAISHA, Toyota-shi (JP)

(21) Appl. No.: 19/407,615

(22) Filed: Dec. 3, 2025

(30) Foreign Application Priority Data
Dec. 12, 2024 (JP) 2024-218187

(51) Int. Cl. G01G 9/00; G01G 19/02

(52) U.S. Cl. CPC G01G 9/00; G01G 19/02

(57) ABSTRACT

A load estimating device for a vehicle including a component that is be subjected to loads caused by a temperature change. A plurality of extremum values in the temperature change of the component are extracted. A plurality of pairs of a temperature change amplitude and a change starting temperature are extracted. A frequency is increased in a corresponding one of a plurality of sections for each one of the plurality of pairs of the extracted temperature change amplitude and the extracted change starting temperature, such that the extracted temperature change amplitude and the extracted change starting temperature of each one of the plurality of pairs fall within a temperature-change amplitude range and a change-starting temperature range of the corresponding one of the plurality of sections, respectively. A total load is estimated based on the frequency in each one of the plurality of sections.

### This application claims priority from Japanese Patent Application No. 2024-218187 filed on Dec. 12, 2024, the disclosure of which is herein incorporated by reference in its entirety.

### FIELD OF THE INVENTION

The present invention relates to a load estimating device for a vehicle.

### BACKGROUND OF THE INVENTION

There is well known a load estimating devices for a vehicle including a component that is to be subjected to a load caused by a temperature change. Patent Document 1 discloses an example of such a load detection device. Patent Document 1 teaches that a temperature difference between adjacent local maximum and minimum values in the temperature change of an electric motor provided in the vehicle is obtained, and then the obtained temperature difference is categorized into a corresponding one of a plurality of sections that are different in terms of a temperature-change amount range, so that al number of occurrences of the temperature change in each of the sections is obtained. Patent Document 1 also teaches that an upper limit value is set in each of the sections, and then a ratio of the number of the occurrences to the upper limit value in each of the sections is calculated, so that an alarm signal is outputted if a sum of the ratios in the respective sections exceeds a threshold value.

### PRIOR ART DOCUMENT

### Patent Document

### [patent Document 1] Jp 2024-42755 a

### SUMMARY OF THE INVENTION

By the way, even if the temperature difference in the temperature change of the component is the same, a magnitude of the load applied to the component could vary depending on a temperature range within which the temperature difference falls. Further, the temperature range in which the magnitude of the applied load is made large could vary depending on a kind of the component. Therefore, it could be difficult to accurately estimate the load applied to the component due to the temperature change.

The present invention has been made in light of the above circumstances, and its purpose is to provide a load estimating device for a vehicle, which is capable of accurately estimating a load applied to a component due to a temperature change.

According to the present invention, there is provided a load estimating device for a vehicle including a component that is be subjected to loads caused by a temperature change. The load estimating device includes a load estimator configured to estimate a total load that is a sum of the loads received by the component. The load estimator extracts a plurality of extremum values including a local maximum value and a local minimum value in the temperature change of the component. The load estimator extracts a plurality of pairs of a temperature change amplitude and a change starting temperature, namely, the temperature change amplitude paired or associated with the change starting temperature, a plurality of times, wherein the temperature change amplitude is a difference between the local maximum value and the local minimum value that are adjacent in time series to each other, and wherein the change starting temperature is one of the local maximum value and the local minimum value that is earlier than the other of the local maximum value and the local minimum value in time series. The load estimator compares each one of the plurality of pairs of the extracted temperature change amplitude and the extracted change starting temperature, with a plurality of sections that are different in terms of a temperature-change amplitude range and a change-starting temperature range. The load estimator increases a frequency in a corresponding one of the plurality of sections for each one of the plurality of pairs of the extracted temperature change amplitude and the extracted change starting temperature, such that the extracted temperature change amplitude and the extracted change starting temperature of each one of the plurality of pairs fall within the temperature-change amplitude range and the change-starting temperature range of the corresponding one of the plurality of sections, respectively. The load estimator estimates the total load, based on the frequency in each one of the plurality of sections.

In the load estimating device according to the present invention, the plurality of extremum values in the temperature change of the component are extracted, the plurality of pairs of the temperature change amplitude and the change starting temperature are extracted, and the frequency is increased in the corresponding one of the plurality of sections for each one of the plurality of pairs of the extracted temperature change amplitude and the extracted change starting temperature, such that the extracted temperature change amplitude and the extracted change starting temperature of each one of the plurality of pairs fall within the temperature-change amplitude range and the change-starting temperature range of the corresponding one of the plurality of sections, respectively. Then, the total load is estimated based on the frequency in each one of the plurality of sections. In this way, by pairing or associating the temperature change amplitude with the change starting temperature, it is possible to record substitute characteristics of the loads applied to the component, wherein the loads vary depending on the temperature range within which the temperature difference fall. This makes it possible to estimate the total load according to characteristic difference in a material of the component. As a result, it is possible to accurately estimate the loads applied to the component due to the temperature change.

### BRIEF DESCRIPTION OF THE DRAWINGS

FIG. 1 is a view schematically showing a construction of a vehicle to which the present invention is applied, and also main parts of control functions and control systems for various controls in the vehicle;

FIGS. 2A-2C are graphs for explaining extraction of a plurality of pairs of a temperature change amplitude and a change starting temperature, wherein FIG. 2A is the graph for explaining extraction of extremum values, FIG. 2B is the graph for explaining extraction of the temperature change amplitude, and FIG. 2C is the graph for explaining extraction of the temperature change amplitude only in cases of temperature reduction;

FIGS. 3A and 3B are tables for explaining the plurality of pairs of the temperature change amplitude and the change starting temperature in cases of temperature reduction of an electric motor, which were extracted using rainflow counting method, wherein FIG. 3A is the table showing examples of extracted temperature reduction amount (as the temperature change amplitude) and reduction starting temperature (as the change starting temperature), and FIG. 3B is the table showing a plurality of sections that are different in terms of a temperature-reduction amount range (as a temperature-change amplitude range) and a reduction-starting temperature range (as a change-starting temperature range);

FIGS. 4A and 4B are views for explaining main parts of a control operation of an electronic control device shown in FIG. 1, wherein FIG. 4A is a flowchart showing the main parts of the control operation of the electronic control device, namely, a control routine executed by the electronic control device for accurately estimating loads applied to the electric motor due to the temperature change, and FIG. 4B is a diagram showing a control flow with the control routine shown in FIG. 4A being executed in a repeated manner;

FIG. 5 is a flowchart showing a subroutine executed at step S10 of the control routine shown in FIG. 4A, for generating a temperature time-series data set; and

FIG. 6 is a flowchart showing a subroutine executed at step S20 of the control routine shown in FIG. 4A, for extracting the plurality of pairs of the temperature change amplitude and the change starting temperature.

### DETAILED DESCRIPTION OF PREFERRED EMBODIMENT

Hereinafter, an embodiment of the present invention will be described in detail with reference to the drawings.

### Embodiment

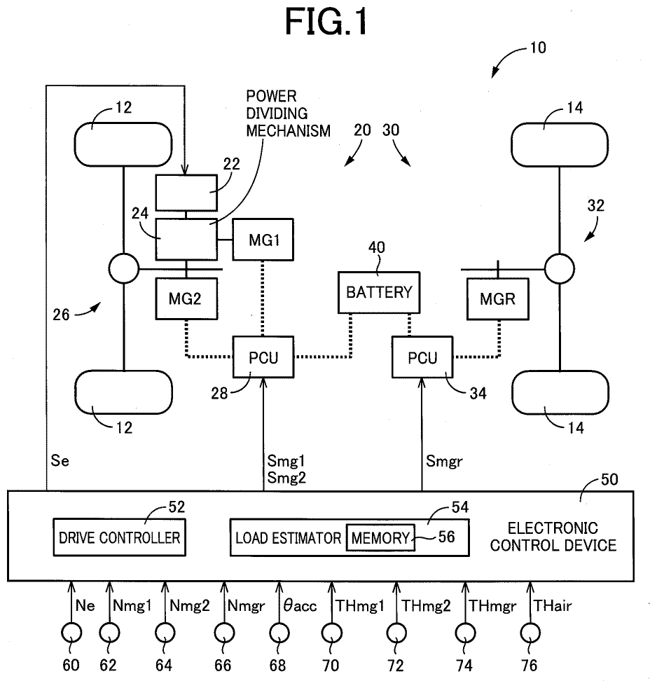

FIG. 1 is a view schematically showing a construction of a vehicle 10 to which the present invention is applied, and also main parts of control functions and control systems for various controls in the vehicle 10. As shown in FIG. 1, the vehicle 10 includes wheels WH consisting of front wheels 12 and rear wheels 14, a front drive unit 20 that drives the front wheels 12, and a rear drive unit 30 that drives the rear wheels 14. The vehicle 10 further includes a battery 40, which is a chargeable and dischargeable DC power source.

The vehicle 10 is a four-wheel drive vehicle with adjustable torque distribution between the front wheels 12 and the rear wheels 14. All-wheel drive (AWD) and four-wheel drive (4WD) are synonymous.

The front drive unit 20 includes an engine 22, a first electric motor MG1, a second electric motor MG2, a power dividing mechanism 24, a front transmission mechanism 26 and a front electric-power control device 28.

The engine 22 is a known internal combustion engine. A torque of the engine 22, which is an engine torque Te, is controlled by an electronic control device 50, which will be described later. The first electric motor MG1 and the second electric motor MG2 are known rotating electric machines, i.e., so-called motor generators. A torque of the first electric motor MG1, which is a first electric motor torque Tmg1, is controlled by the electronic control device 50 controlling the front electric-power control device 28. A torque of the second electric motor MG2, which is a second electric motor torque Tmg2, is controlled by the electronic control device 50 controlling the front electric-power control device 28. The engine 22 and the second electric motor MG2 function as power sources for driving the vehicle 10.

The power dividing mechanism 24 is, for example, a known single-pinion type planetary gear device including a carrier, a sun gear and a ring gear. The power dividing mechanism 24 mechanically divides a power of the engine 22 inputted to the carrier, between the sun gear and the ring gear, for example. The first electric motor MG1 is connected to the sun gear in a power transmittable manner. In the power dividing mechanism 24, the first electric motor torque Tmg1 takes on a reaction force of the engine torque Te whereby direct torque is transmitted to the ring gear. The ring gear is an output rotary member of the power dividing mechanism 24, and the second electric motor MG2 is connected to the ring gear in a power transmittable manner. The second electric motor MG2 is driven by the power generated by the first electric motor MG1 and/or by the power supplied from the battery 40. A known electric continuously variable transmission is constituted by the power dividing mechanism 24 and the first electric motor MG1, wherein a differential state of the power dividing mechanism 24 is controlled with an operating state of the first electric motor MG1 being controlled.

The front transmission mechanism 26 includes drive shafts and a reduction gear mechanism including a differential gear device, for example, and transmits the power outputted from the power dividing mechanism 24 and the power outputted from the second electric motor MG2, to the front wheels 12.

The battery 40 is a high-voltage battery for driving the vehicle. The battery 40 is electrically connected to the front electric-power control device 28. The front electric-power control device 28 is equipped with, for example, an inverter. The front electric-power control device 28 is electrically connected to the first electric motor MG1 and the second electric motor MG2. The front electric-power control device 28 is a power control unit PCU (Power Control Unit) that controls the power exchanged between the battery 40 and each of the first electric motor MG1 and the second electric motor MG2. The front electric-power control device 28 converts DC power from the battery 40 into AC power for driving the first electric motor MG1 and the second electric motor MG2. The front electric-power control device 28 converts the AC power generated by each of the first electric motor MG1 and the second electric motor MG2 into the DC power, and supplies the DC power to the battery 40.

The rear drive unit 30 includes a rear electric motor MGR, a rear transmission mechanism 32 and a rear electric-power control device 34.

The rear electric motor MGR is a known rotating electric machine, i.e., a so-called motor generator. A torque of the rear electric motor MGR, which is a rear electric motor torque Tmgr, is controlled by the electronic control device 50 controlling the rear electric-power control device 34. The rear electric motor MGR functions as a power source for driving the vehicle 10.

The rear transmission mechanism 32 includes drive shafts and a reduction gear mechanism including a differential gear device, and transmits the power outputted from the rear electric motor MGR, to the rear wheels 14.

The battery 40 is electrically connected to the rear electric-power control device 34. The rear electric-power control device 34 is equipped with, for example, an inverter. The rear electric-power control device 34 is electrically connected to the rear electric motor MGR. The rear electric-power control device 34 is a PCU that controls the power exchanged between the battery 40 and the rear electric motor MGR. The rear electric-power control device 34 converts the DC power supplied from the battery 40, into the AC power for driving the rear electric motor MGR. The rear electric-power control device 34 converts the AC power generated by the rear electric motor MGR into the DC power, and supplies the DC power to the battery 40.

The vehicle 10 is provided with the electronic control device 50 as a controller including a control device for the vehicle 10. The electronic control device 50 includes a so-called microcomputer equipped with CPU, RAM, ROM, input/output interface, for example. The CPU executes various controls of the vehicle 10 by, for example, utilizing a temporary storage function of the RAM and performing signal processing in accordance with programs previously stored in the ROM.

The electronic control device 50 is supplied with various signals based on values detected by various sensors provided in the vehicle 10. The various sensors include an engine speed sensor 60, a first-electric-motor speed sensor 62, a second-electric-motor speed sensor 64, a rear-electric-motor speed sensor 66, an accelerator-opening degree sensor 68, a first-electric-motor temperature sensor 70, a second-electric-motor temperature sensor 72, a rear-electric-motor temperature sensor 74 and an outside temperature sensor 76. The various signals include signals indicative of an engine rotational speed Ne, a first-electric-motor rotational speed Nmg1, a second-electric-motor rotational speed Nmg2, a rear-electric-motor rotational speed Nmgr, an accelerator opening degree θacc, a first-electric-motor temperature THmg1, a second-electric-motor temperature THmg2, a rear-electric-motor temperature THmgr and an outside temperature THair.

The first-electric-motor temperature THmg1 is a temperature of the first electric motor MG1. The second-electric-motor temperature THmg2 is a temperature of the second electric motor MG2. The rear-electric-motor temperature THmgr is a temperature of the rear electric motor MGR. The outside temperature THair is a temperature outside vehicle 10, i.e., a temperature around the vehicle 10.

Various command signals are outputted from the electronic control device 50 to various devices provided in vehicle 10, such as the engine 22, the front electric-power control device 28 and the rear electric-power control device 34. The various command signals include an engine control command signal Se, a first-electric-motor control command signal Smg1, a second-electric-motor control command signal Smg2 and a rear-electric-motor control command signal Smgr.

The electronic control device 50 is equipped with a drive controller 52 to realize various controls in the vehicle 10.

The drive controller 52 calculates the required drive torque Twdem for the vehicle 10, for example, by applying the accelerator opening degree θacc and the vehicle speed V to a predetermined drive demand map. The required drive torque Twdem is a required value of the drive torque Tw, which is the torque at each of the wheels WH. The drive torque Tw is a sum of a front wheel torque Twf, which is the torque at each of the front wheels 12, and a rear wheel torque Twr, which is the torque at each of the rear wheels 14. It is noted that, unless otherwise specified, torque and force (driving force) are synonymous.

The drive controller 52 sets a torque distribution ratio between the front and rear wheels based on a plurality of drive-force-related values such as the accelerator opening degree θacc, vehicle running speed, longitudinal acceleration and yaw rate. The drive controller 52 calculates a required front wheel torque Twfdem and a required rear wheel torque Twrdem based on the required drive torque Twdem and the torque distribution ratio. The required front wheel torque Twfdem is a required value of the front wheel torque Twf. The required rear wheel torque Twrdem is a required value of the rear wheel torque Twr. The drive controller 52 outputs the engine control command signal Se, the first-electric-motor control command signal Smg1 and the second-electric-motor control command signal Smg2 to control the front drive unit 20 so as to realize the required front wheel torque Twfdem. The drive controller 52 outputs the rear-electric-motor control command signal Smgr to control the rear drive unit 30, i.e., the rear electric motor MGR, so as to realize the required rear wheel torque Twrdem.

Here, the first electric motor MG1, second electric motor MG2 and rear electric motor MGR generate heat during their operations, causing an electric motor temperature THmg (THmg1, THmg2, THmgr) to be fluctuated. The fluctuations in the electric motor temperature THmg apply the loads B to the electric motor MG, which may reduce durability of the electric motor MG. For example, resins such as insulators in coil parts used in electric motor MG are subjected to the loads B due to fluctuation of the electric motor temperature THmg, which may reduce their durability. The electric motors MG are components that are subjected to the loads B due to the fluctuation of the electric motor temperature THmg, i.e., temperature change.

The loads B caused by the temperature change on the electric motor MG are increased as the temperature change is increased. Further, a total of the loads B is increased as a frequency of the temperature change is increased. Therefore, it is possible to estimate the total load Btotal, which is a sum of the loads B applied to the electric motor MG, by detecting the temperature difference during the temperature change and the frequency of the temperature difference. However, even if the temperature difference during the temperature change on the electric motor MG is the same, a magnitude of the loads B may vary depending on a temperature range within which that temperature difference falls. For example, different resin materials may have different glass transition temperatures, and the temperature range, in which the temperature change passe through the glass transition temperature or in which the loads B are increased, may vary depending on the resin material. Thus, it could be difficult to accurately estimate the loads B.

To address the above-mentioned problems, in the present invention, the total load Btotal is estimated by focusing on the temperature range within which the temperature difference in the temperature change of the electric motor MG falls. The electronic control device 50 further includes a load estimator 54 that estimates the total load Btotal. The electronic control device 50 functions as the load estimating device of the present invention.

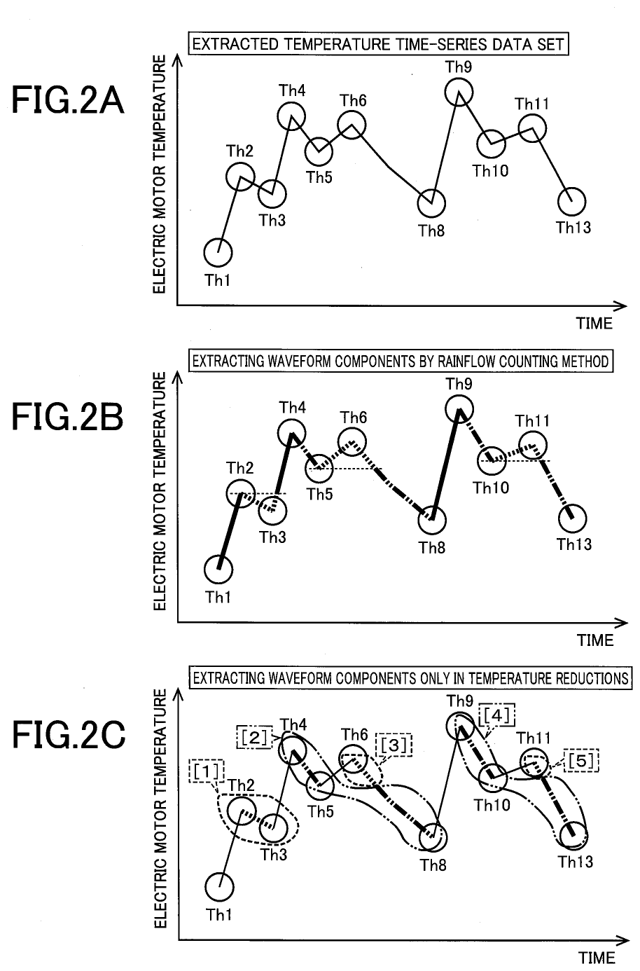

The load estimator 54 estimates the total load Btotal, for example, in each of the first electric motor MG1, the second electric motor MG2 and the rear electric motor MGR. The total load Btotal in the electric motor MG represents the total load Btotal in one of the first electric motor MG1, second electric motor MG2 and rear electric motor MGR. Also, the “MG #TEMPERATURE” shown in FIGS. 2, 4 and 5 is the electric motor temperature THmg, and represents one of the first-electric-motor temperature THmg1, second-electric-motor temperature THmg2 and rear-electric-motor temperature THmgr.

The load estimator 54 extracts extremum values including local maximum values and local minimum values in the temperature change of the electric motor MG. The load estimator 54 extracts a plurality of pairs of a temperature change amplitude ΔT and a change starting temperature Ths, namely, extracts the temperature change amplitude ΔT paired or associated with the change starting temperature Ths, a plurality of times. The temperature change amplitude ΔT is a difference between the local maximum value and the local minimum value that are adjacent in time series to each other, and the change starting temperature Ths is one of the local maximum value and the local minimum value that is earlier than the other of the local maximum value and the local minimum value in time series. The temperature change amplitude ΔT is a temperature amplitude component that is the difference between adjacent local maximum values and local minimum values. The temperature amplitude component substitutes for a stress amplitude component. The “stress” in the stress amplitude component represents, for example, a change due to the temperature in the resin material, and the temperature is used as a substitute characteristic. The load estimator 54 compares each one of the plurality of pairs of the extracted temperature change amplitude ΔT and the extracted change starting temperature Ths, with a plurality of sections DIVa that are different in terms of a temperature-change amplitude range and a change-starting temperature range RNGt. Then, the load estimator 54 increases a frequency (i.e., number of times) H in a corresponding one of the plurality of sections DIVa for each one of the plurality of pairs of the extracted temperature change amplitude ΔT and the extracted change starting temperature Ths, such that the extracted temperature change amplitude ΔT and the extracted change starting temperature Ths of each one of the plurality of pairs fall within the temperature-change amplitude range and the change-starting temperature range RNGt of the corresponding one of the plurality of sections DIVa, respectively. The plurality of sections DIVa are sections into which extracted values of the temperature change amplitude ΔT and extracted values of the change starting temperature Ths are categorized. The load estimator 54 estimates the total load Btotal, based on the frequency H in each one of the plurality of sections DIVa. The total load Btotal is the total load Btotal of each of the electric motor MG.

FIGS. 2A-2C are graphs for explaining extraction of the plurality of pairs of the temperature change amplitude ΔT and the change starting temperature Ths, wherein FIG. 2A is the graph for explaining extraction of the extremum values, FIG. 2B is the graph for explaining extraction of the temperature change amplitude ΔT, and FIG. 2C is the graph for explaining extraction of the temperature change amplitude ΔT only in cases of temperature reduction.

A waveform in FIG. 2A shows a waveform in which peaks and valleys are extracted from time series data of the temperature change of the electric motor MG. The peaks of the time series data indicate the local maximum values, and the valleys of the time series data indicate the local minimum values. The load estimator 54 temporarily stores the plurality of extracted extremum values in temperature time-series data, which is time-series data of the temperature change. In the present embodiment, the temperature time-series data as a set is referred to as a temperature time-series data set (see FIG. 2A). The load estimator 54 includes a memory 56, and stores the temperature time-series data in the memory 56.

An example of generation of the temperature time-series data set will be described below. The load estimator 54 acquires the electric motor temperature THmg. The load estimator 54 determines whether the obtained electric motor temperature THmg is an extremum value or not. When determining that the obtained electric motor temperature THmg is an extremum value, the load estimator 54 determines whether a difference between the obtained electric motor temperature THmg and the latest data is larger than a predetermined extreme value difference. The latest data is the most recent extremum value of the temperature time-series data. When determining that the difference between the obtained electric motor temperature THmg and the latest data is larger than the predetermined extreme value difference, the load estimator 54 adds the obtained electric motor temperature THmg to the temperature time-series data set. When determining that the difference between the obtained electric motor temperature THmg and the latest data is equal to or smaller than the predetermined extreme value difference, the load estimator 54 does not add the obtained electric motor temperature THmg to the temperature time-series data set. That is, when the difference between the extracted extremum value and the extremum value previously stored in the temperature time-series data is smaller than the predetermined extreme value difference, the extracted extremum value will not be stored in the temperature time-series data. This makes it possible to reduce a volume of space required for temporary storage by omitting data processing that has little impact on the loads B. The predetermined extreme value difference is a predetermined threshold for determining whether to add the extremum values that have little impact on the loads B, for example. One of the extracted extremum values and the previously stored extremum values is the local maximum value, and the other is the local minimum value.

When a predetermined condition CDf is satisfied, the load estimator 54 ends storing the plurality of extracted extremum values in a current temperature time-series data set that is a current set of the temperature time-series data, and starts storing the extremum values in a new temperature time-series data set that is a new set of the temperature time-series data. The predetermined condition CDf is, for example, a condition CDa that the latest electric motor temperature THmg stored in the temperature time-series data set falls within a predetermined temperature difference from the outside temperature THair. The predetermined temperature difference is, for example, a predetermined threshold for determining that the electric motor MG has cooled down and the electric motor temperature THmg has become close to the outside temperature THair. This makes it possible to reduce a length of data to be temporarily stored. Alternatively, the predetermined condition CDf is, for example, a condition CDb that a number of points in the temperature time-series data set, i.e., the number of the extremum values, has reached a predetermined number. The predetermined number is, for example, a value that is set when the volume of temporarily stored temperature time-series data has reached a predetermined number. This is a predetermined threshold for determining that an amount of the extremum values has reached an appropriate level. This makes it possible to reduce the length of data to be temporarily stored. When either the condition CDa or condition CDb is satisfied, the load estimator 54 ends the storage of the extremum values in the current temperature time-series data set and starts storing the extremum values in the new temperature time-series data set. This makes it possible to minimize the length of data to be temporarily stored. The load estimator 54 determines whether the temperature difference between the outside temperature THair and the electric motor temperature THmg added to the temperature time-series data set is larger than a predetermined temperature difference. The load estimator 54 determines whether the number of points in the temperature time-series data set is smaller than a predetermined number. When determining that the temperature difference between the outside temperature THair and the electric motor temperature THmg is within the predetermined temperature difference, the load estimator 54 ends the storage of extremum values in the current temperature time-series data set, and starts storing the extremum values in the new temperature time-series data set. Alternatively, when determining that the number of points in the temperature time-series data set has reached the predetermined number, the load estimator 54 ends the current storage of extremum values in the current temperature time-series data set, and starts storing the extremum values in the new temperature time-series data set.

When the load estimator 54 starts storing extremum values in the new temperature time-series data set as a result of the predetermined condition CDf being satisfied, the load estimator 54 uses the last extremum values in the current temperature time-series data set for which storage has been just ended, as first extremum values in the new temperature time-series data set. This makes it possible to accurately extract the temperature change amplitude ΔT in the new temperature time-series data set.

In parallel with storing the extremum values in the newly started temperature time-series data, the load estimator 54 extracts the plurality of pairs of the temperature change amplitude ΔT and the change starting temperature Ths by using the current temperature time-series data for which the storage has been ended, and increases the frequency H in the corresponding one of the plurality of sections DIVa such that the extracted temperature change amplitude ΔT and the extracted change starting temperature Ths of each one of the plurality of pairs fall within the temperature-change amplitude range and the change-starting temperature range of the corresponding one of the plurality of sections DIVa, respectively.

The transition to a temperature-amplitude counting operation, by which the temperature change amplitude ΔT and the change starting temperature Ths of the plurality of pairs are extracted, is made when the predetermined condition CDf is satisfied for each of the first-electric-motor temperature THmg1, second-electric-motor temperature THmg2 and rear-electric-motor temperature THmgr. This makes it possible to execute the temperature-amplitude counting operation under the same conditions for each of the first-electric-motor temperature THmg1, second-electric-motor temperature THmg2 and rear-electric-motor temperature THmgr.

If a processing load in the temperature-amplitude counting operation becomes large, the temperature-amplitude counting operation is performed in separate processing cycles. For example, the temperature-amplitude counting operation for the first-electric-motor temperature THmg1, the second-electric-motor temperature THmg2 and the rear-electric-motor temperature THmgr is performed in separate processing cycles. Alternatively, the generation of the temperature time-series data set and the temperature-amplitude counting operation may be performed in separate processing cycles. This allows the necessary processing to be performed without placing an excessive load on the electronic control device 50.

As described above, the load estimator 54 temporarily stores the extracted multiple extremum values in the temperature time-series data, and then extracts the plurality of pairs of the temperature change amplitude ΔT and the change starting temperature Ths, namely, the plurality of temperature change amplitudes ΔT and the plurality of change starting temperatures Ths, by using the stored temperature time-series data. For example, as shown in FIG. 2B, the load estimator 54 extracts the temperature change amplitudes ΔT by using a known rainflow counting method. In FIG. 2B, a solid line Th1-Th2-Th4 indicates one of the temperature change amplitudes ΔT in cases of temperature increase, and a two-dot chain line Th4-Th5-Th8 indicates one of the temperature change amplitudes ΔT in cases of temperature reduction. The others of the temperature change amplitudes ΔT also are extracted in similar manners. In this way, the load estimator 54 extracts the plurality of temperature change amplitudes ΔT and the plurality of change starting temperatures Ths collectively from the temperature time-series data set, for example. Also, by using the rainflow counting method, it is possible to more accurately calculate the loads B, since the rainflow counting method reflects a way in which the damage is inflicted on the electric motor MG.

The load estimator 54 extracts the temperature change amplitude ΔT only in case of either temperature increase or reduction, namely, extracts, as the temperature change amplitude ΔT, only one of a temperature increase amount that is the difference between the local minimum value as the change starting temperature Ths and the local maximum value, and a temperature reduction amount that is the difference between the local maximum value as the change starting temperature Ths and the local minimum value. For example, as shown in FIG. 2C, the load estimator 54 extracts only the temperature reduction amount that is the difference between the local maximum value as the change starting temperature Ths and the local minimum value, from the temperature change amplitudes ΔT extracted by the rainflow counting method. It is noted that, although only the temperature reduction amount is extracted in the present embodiment, only the temperature increase amount that is the difference between the local minimum value as the change starting temperature Ths and the local maximum value, may be extracted from the temperature change amplitudes ΔT extracted by the rainflow counting method.

After having extracted the plurality of the temperature change amplitude ΔT and the change starting temperature Ths from the temperature time-series data set, the load estimator 54 may delete that temperature time-series data set. However, if there is no problem, the load estimator 54 may overwrite the temperature time-series data set from which the plurality of the temperature change amplitude ΔT and the change starting temperature Ths have been extracted, with the new temperature time-series data without deleting it.

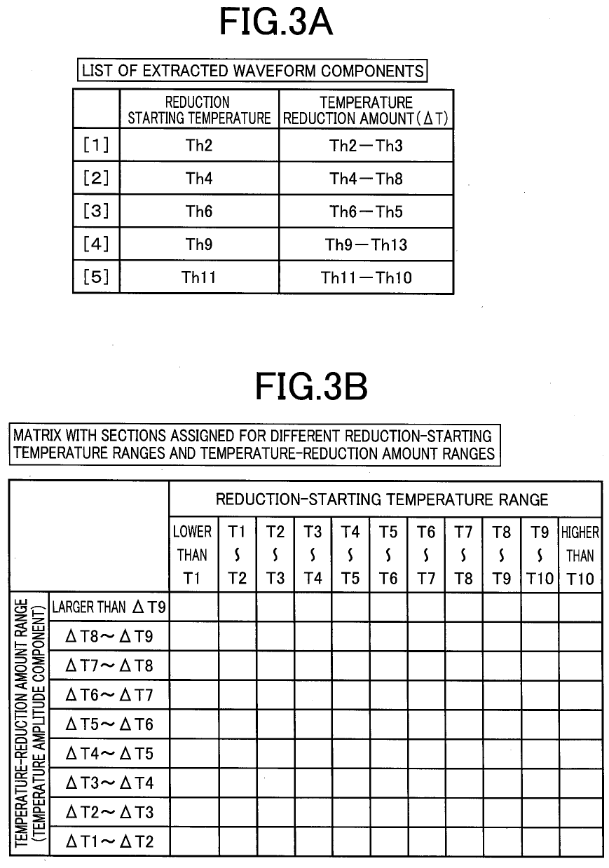

FIGS. 3A and 3B are tables for explaining the plurality of pairs of the temperature change amplitude ΔT and the change starting temperature Ths in cases of the temperature reduction of the electric motor MG, which were extracted using the rainflow counting method, wherein FIG. 3A is the table showing examples of extracted temperature reduction amount (as the temperature change amplitude ΔT) and reduction starting temperature (as the change starting temperature Ths), and FIG. 3B is the table (matrix) showing the plurality of sections (cells) DIVa that are different in terms of a temperature-reduction amount range (as the temperature-change amplitude range) and a reduction-starting temperature range (as the change-starting temperature range RNGt).

FIG. 3A shows the examples of the temperature reduction amount, which is the temperature change amplitude ΔT in cases of the temperature reduction of the electric motor MG, and also the examples of the reduction starting temperature, which is the change starting temperature Ths in cases of the temperature reduction of the electric motor MG, wherein the examples of the temperature reduction amount and the reduction starting temperature are shown in FIG. 2C. The plurality of sections DIVa shown in FIG. 3B cover 11 reduction-starting temperature ranges “LOWER THAN T1”, “T1-T2”, “T2-T3”, “T3-T4”, “T4-T5”, “T5-T6”, “T6-T7”, “T7-T8”, “T8-T9”, “T9-T10”, “HIGHER THAN T 10” and 9 temperature-reduction amount ranges “ΔT 1-ΔT2”, “ΔT 2-ΔT3”, “ΔT3-ΔT4”, “ΔT4-ΔT5”, “ΔT5-ΔT6”, “ΔT6-ΔT7”, “ΔT7-ΔT8”, “ΔT8-ΔT9”, “ LARGER THAN ΔT 9”, so that a total number of the plurality of sections DIVa is 99 (=11 ×9). Each of the plurality of sections DIVa is assigned for a corresponding one of the 11 reduction-starting temperature ranges and a corresponding one of the 9 temperature-reduction amount ranges. For example, when the reduction starting temperature Th2 falls within the reduction-starting temperature range “T1-T2” and the temperature reduction amount “Th2-Th3” falls within the temperature-reduction amount range “ΔT2-ΔT3”, the frequency H in the section DIVa of “T1-T2” and “ΔT2-ΔT3” is increased by one. The 11 reduction-starting temperature ranges shown in FIG. 3B may be equal to each other in width, or may be different from each other in width considering an influence damaging the electric motor MG. The 9 temperature-reduction amount ranges shown in FIG. 3B may be equal to each other in width, or may be different from each other in width considering an influence damaging the electric motor MG.

For each of the plurality of sections DIVa, which are different in terms of the temperature-change amplitude range and the change-starting temperature range RNGt, the loads to be applied to the electric motor MG are weighted in advance. The load estimator 54 estimates the total load Btotal based on the weighted loads Bxy and the frequency Hxy in each of the plurality of sections DIVa. For example, the load estimator 54 multiples the weighted loads Bxy by the frequency Hxy in each of the plurality of sections DIVa, and calculates, as the total load Btotal, a sum of the multiplications (=Bxy×Hxy) in all of the plurality of sections DIVa.

When the load estimator 54 determines that a temperature signal indicative of the electric motor temperature THmg from the electric motor temperature sensors (70, 72, 74) is unreliable, the load estimator 54 does not temporarily store the temperature time-series data set. This prevents the loads B of the electric motor MG from being erroneously recorded.

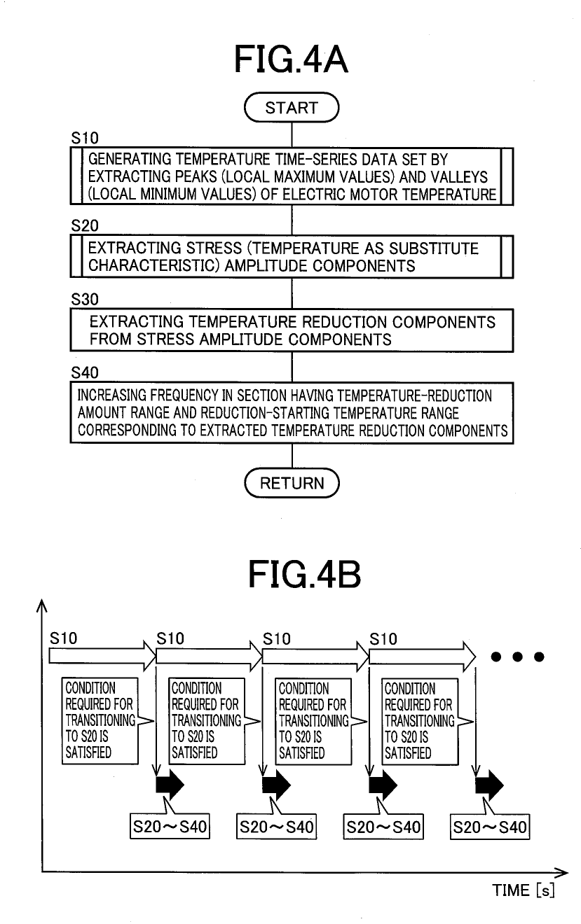

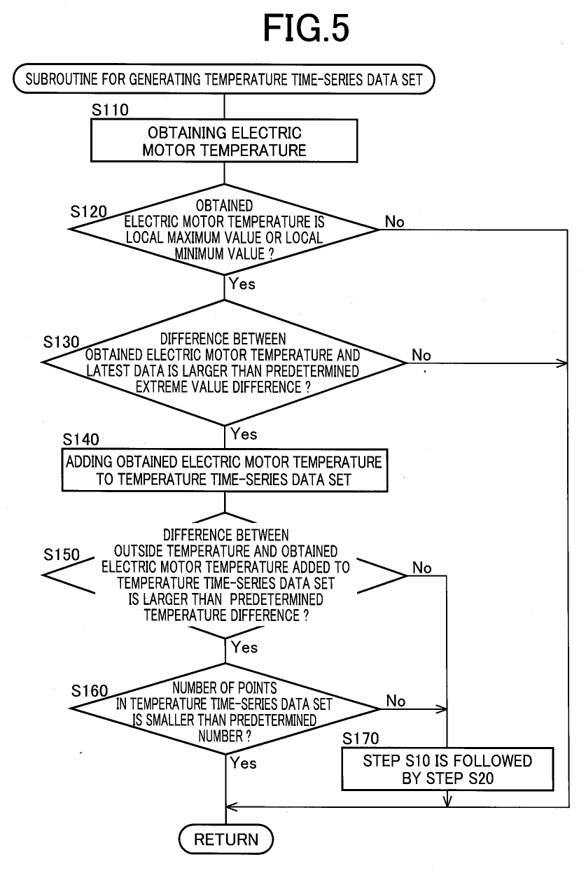

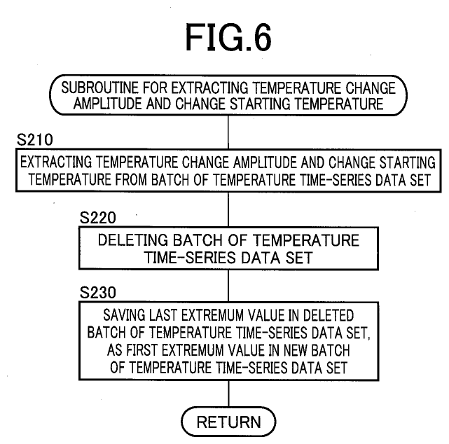

FIGS. 4A and 4B are views for explaining main parts of a control operation of the electronic control device 50, wherein FIG. 4A is a flowchart showing the main parts of the control operation of the electronic control device 50, namely, a control routine executed by the electronic control device 50 for accurately estimating the loads B applied to the electric motor MG due to the temperature change, and FIG. 4B is a diagram showing a control flow with the control routine shown in FIG. 4A being executed in a repeated manner. FIG. 5 is a flowchart showing a subroutine executed at step S10 of the control routine shown in FIG. 4A, for generating the temperature time-series data set. FIG. 6 is a flowchart showing a subroutine executed at step S20 of the control routine shown in FIG. 4A, for extracting the plurality of pairs of the temperature change amplitude ΔT and the change starting temperature Ths.

As shown in FIG. 4A, the control routine, whose steps correspond to function of the load estimator 54, is initiated with step S10 that is implemented to generate the temperature time-series data set by extracting the peaks (local maximum values) and the valleys (local minimum values) of the electric motor temperature THmg, and then step S20 is implemented to extract the temperature change amplitude ΔT as a stress amplitude component.

FIG. 5 is the flowchart showing the subroutine executed at step S10 at which the temperature time-series data set is generated. The subroutine is initiated with step S110 that is implemented to obtain the electric motor temperature THmg. Then, step S120 is implemented to determine whether the obtained electric motor temperature THmg is an extremum value (local maximum value or local minimum value). When a negative determination is made at step S120, one cycle of execution of the subroutine is terminated. When an affirmative determination is made at step S120, step S130 is implemented to determine whether a difference between the obtained electric motor temperature THmg and the latest data is larger than the predetermined extreme value difference. When a negative determination is made at step S130, one cycle of execution of the subroutine is terminated. When an affirmative determination is made at step S130, step S140 is implemented to add the obtained electric motor temperature THmg to the temperature time-series data set. Next, at step S150, it is determined whether a difference between the outside temperature and the obtained electric motor temperature THmg added to the temperature time-series data set is larger than the predetermined temperature difference. When an affirmative determination is made at step S150, step S160 is implemented to determine whether the number of points in the temperature time-series data set is smaller than a predetermined number. When an affirmative determination is made at step S160, one cycle of execution of the subroutine is terminated. When a negative determination is made at step S150 or S160, the control flow goes to step S170 at which step S10 is followed by step S20 in the control routine shown in FIG. 4A, and one cycle of execution of the subroutine is terminated.

FIG. 6 is the flowchart showing the subroutine executed at step S20 at which the plurality of pairs of the temperature change amplitude ΔT and the change starting temperature Ths are extracted. The subroutine is initiated with step S210 that is implemented to extract the temperature change amplitude ΔT and the change starting temperature Ths a plurality of times from a batch of the temperature time-series data set. Next, at step S220, the batch of temperature time-series data set is deleted. Next, at step S230, the last extremum value in the deleted batch of the temperature time-series data set is saved as a first extremum value in a new batch of the temperature time-series data set that is to be generated, and one cycle of execution of the subroutine is terminated.

Referring back to FIG. 4A, steps S10 and S20 are followed by step S30 that is implemented to extract the plurality of pairs of the temperature reduction amount and the reduction starting temperature from the plurality of pairs of the extracted temperature change amplitudes ΔT and change starting temperature Ths. Next, at step S40, the frequency (i.e., number of times) H is increased in a corresponding one of the plurality of sections DIVa for each one of the plurality of pairs of the extracted temperature reduction amount and reduction starting temperature, such that the extracted temperature reduction amount and reduction starting temperature of each one of the plurality of pairs fall within the temperature-reduction amount range and the reduction-starting temperature range of the corresponding one of the plurality of sections DIVa, respectively. Then, one cycle of execution of the control routine is terminated.

In FIG. 4B, if a condition required for transitioning to step S20 is satisfied at step S10, step S10 starts to be newly implemented. In parallel with new implementation of step S10, steps S20 to S40 are implemented (see step S170 in FIG. 5). These control operations are executed repeatedly. A timing for transitioning to step S20 is made concurrent with a timing at which the condition required for transitioning to step S20 is satisfied each of the first electric motor temperature THmg1, second electric motor temperature THmg2 and rear electric motor temperature THmgr. When implementations of steps S20 to S40 in one processing cycle would increase the processing load, the implementations of steps S20 to S40 may be made separately from the implantation of step S10, for example. Further, if the temperature signal indicative of the electric motor temperature THmg obtained at step S110 is unreliable, step S120 and the subsequent steps for the electric motor temperature THmg are not implemented.

As described above, in the present embodiment, the plurality of extremum values in the temperature change of the electric motor MG are extracted, the plurality of pairs of the temperature change amplitude ΔT and the change starting temperature Ths are extracted, and the frequency H is increased in a corresponding one of the plurality of sections DIVa for each one of the plurality of pairs of the extracted temperature change amplitude ΔT and the extracted change starting temperature Ths, such that the extracted temperature change amplitude ΔT and the extracted change starting temperature Ths of each one of the plurality of pairs fall within the temperature-change amplitude range and the change-starting temperature range of the corresponding one of the plurality of sections DIVa, respectively. Then, the total load Btotal is estimated based on the frequency H in each one of the plurality of sections DIVa. In this way, by associating the temperature change amplitude ΔT with the change starting temperature Ths, it is possible to record substitute characteristics of the loads B applied to a constituent component of the electric motor MG, wherein the loads B vary depending on the temperature range within which the temperature difference fall. This makes it possible to estimate the total load Btotal according to characteristic difference in a material of the constituent component of the electric motor MG. As a result, it is possible to accurately estimate the loads B applied to the electric motor MG due to the temperature change.

Further, in the present embodiment, the temperature change amplitude ΔT is extracted only in case of either the temperature increase or reduction, namely, only one of the temperature increase amount (that is the difference between the local minimum value as the change starting temperature Ths and the local maximum value) and the temperature reduction amount (that is the difference between the local maximum value as the change starting temperature Ths and the local minimum value) is extracted as the temperature change amplitude ΔT. This allows for saving a storage capacity of the memory 56 by limiting extraction of the temperature change amplitude ΔT to only one of the temperature increase amount and the temperature reduction amount.

Further, in the present embodiment, the plurality of extracted extremum values are temporarily stored in the temperature time-series data, and then the plurality of pairs of the temperature change amplitude ΔT and the change starting temperature Ths are extracted by using the plurality of extracted extremum values stored in the temperature time-series data. This makes it possible to conveniently select a timing for extracting the temperature change amplitude ΔT and the change starting temperature Ths from the temperature time-series data set. Further, because the temperature change amplitude ΔT and the change starting temperature Ths are not extracted each time the extremum values are extracted, the load on the electronic control device 50 during normal operation can be reduced.

Further, in the present embodiment, when the predetermined condition CDf is satisfied, the storage of the plurality of extracted extremum values in the current temperature time-series data set is ended, and the storage of the plurality of extracted extremum values in the new temperature time-series data set is started. In addition, in parallel with the storage of the extremum values in the new temperature time-series data set, the plurality of pairs of the temperature change amplitude ΔT and the change starting temperature Ths are extracted by using the current temperature time-series data set for which storage has been ended, and the frequency is increased in the corresponding one of the plurality of sections DIVa such that the extracted temperature change amplitude ΔT and the extracted change starting temperature Ths of each one of the plurality of pairs fall within the temperature-change amplitude range and the change-starting temperature range of the corresponding one of the plurality of sections DIVa, respectively. Consequently, even during running of the vehicle 10, a size of the temperature time-series data set can be kept within a range that falls within a limited temporary storage area, without suspending the storage of the extremum values in the temperature time-series data.

Further, in the present embodiment, the weighting of the loads B received by the electric motor MG is made in advance in each of the plurality of sections DIVa that are different in terms of the temperature-change amplitude range and the change-starting temperature range, and the total load Btotal is estimated based on the frequency Hxy and the weighted loads Bxy in each one of the plurality of sections DIVa. Moreover, the total load Btotal is estimated, by multiplying the weighted loads Bxy by the frequency Hxy in each one of the plurality of sections DIVa, and calculating, as the total load Btotal, the sum of multiplications (Bxy×Hxy) of the weighted loads Bxy and the frequency Hxy in all of the plurality of sections DIVa. This makes it possible to accurately indicate the degree of damage to the component, leading to appropriate measures.

Although the embodiment of the present invention has been described in detail above with reference to the drawings, the present invention can also be applied to other embodiments.

For example, in the above-described embodiment, each of the first electric motor MG1, second electric motor MG2 and rear electric motor MGR is exemplified as the component that is to be subjected to the loads B caused by the temperature change, but the present invention is not limited to this detail. For example, the component that is to be subjected to the loads B caused by the temperature change may be at least one of the first electric motor MG1, second electric motor MG2 and rear electric motor MGR. Alternatively, the component that is to be subjected to the loads B caused by the temperature change may be a component located near the electric motor MG. In short, the present invention can be applied to any vehicle equipped with a component that is subject to the loads B due to the temperature change.

Further, in the above-described embodiment, the estimation of the total load Btotal and the estimation of the degree of damage to the component may be performed by using AI estimation such as a learning model based on machine learning. For example, the weighted loads Bxy may be learned in advance for each component, and the estimated total load Btotal may be outputted by inputting a name of the component, the temperature change amplitude ΔT and the change starting temperature Ths, for example. Alternatively, the estimated total load Btotal may be outputted by inputting the measured temperature of the component into a learning model having function of the load estimator 54.

It should be noted that the above is merely one embodiment, and the present invention can be embodied in various forms with various modifications and improvements based on the knowledge of those skilled in the art.

NOMENCLATURE OF ELEMENTS
10: vehicle
50: electronic control device (load estimating device)
54: load estimator
MG: electric motor (component subject to loads caused by temperature change)

What is claimed is:

1. A load estimating device for a vehicle including a component that is be subjected to loads caused by a temperature change,
the load estimating device comprising:
a load estimator configured to estimate a total load that is a sum of the loads received by the component,
wherein the load estimator extracts a plurality of extremum values including a local maximum value and a local minimum value in the temperature change of the component,
wherein the load estimator extracts a plurality of pairs of a temperature change amplitude and a change starting temperature, such that the temperature change amplitude is a difference between the local maximum value and the local minimum value that are adjacent in time series to each other, and such that the change starting temperature is one of the local maximum value and the local minimum value that is earlier than the other of the local maximum value and the local minimum value in time series,
wherein the load estimator compares each one of the plurality of pairs of the extracted temperature change amplitude and the extracted change starting temperature, with a plurality of sections that are different in terms of a temperature-change amplitude range and a change-starting temperature range,
wherein the load estimator increases a frequency in a corresponding one of the plurality of sections for each one of the plurality of pairs of the extracted temperature change amplitude and the extracted change starting temperature, such that the extracted temperature change amplitude and the extracted change starting temperature of each one of the plurality of pairs fall within the temperature-change amplitude range and the change-starting temperature range of the corresponding one of the plurality of sections, respectively, and
wherein the load estimator estimates the total load, based on the frequency in each one of the plurality of sections.

2. The load estimating device according to claim 1,
wherein the load estimator extracts, as the temperature change amplitude, one of a temperature increase amount that is the difference between the local minimum value as the change starting temperature and the local maximum value, and a temperature reduction amount that is the difference between the local maximum value as the change starting temperature and the local minimum value.

3. The load estimating device according to claim 1,
wherein the load estimator temporarily stores the plurality of extracted extremum values in temperature time-series data that is time-series data of the temperature change, and then extracts the plurality of pairs of the temperature change amplitude and the change starting temperature, by using the plurality of extracted extremum values stored in the temperature time-series data.

4. The load estimating device according to claim 3,
wherein, when a predetermined condition is satisfied, the load estimator ends storing the plurality of extracted extremum values in a current temperature time-series data set that is a current set of the temperature time-series data, and starts storing the extremum values in a new temperature time-series data set that is a new set of the temperature time-series data,
wherein, in parallel with storing the extremum values in the new temperature time-series data set, the load estimator extracts the plurality of pairs of the temperature change amplitude and the change starting temperature by using the current temperature time-series data set for which storage has been ended, and increases the frequency in the corresponding one of the plurality of sections such that the extracted temperature change amplitude and the extracted change starting temperature of each one of the plurality of pairs fall within the temperature-change amplitude range and the change-starting temperature range of the corresponding one of the plurality of sections, respectively.

5. The load estimating device according to claim 1,
wherein a weighting of the loads received by the component is made in advance in each of the plurality of sections that are different in terms of the temperature-change amplitude range and the change-starting temperature range, and
wherein the load estimator estimates the total load, based on the frequency and the weighted loads in each one of the plurality of sections.

6. The load estimating device according to claim 5,
wherein the load estimator estimates the total load, by multiplying the weighted loads by the frequency in each one of the plurality of sections, and calculating, as the total load, a sum of multiplications of the weighted loads and the frequency in all of the plurality of sections.
